(19) United States
(12) Patent Application Publication
(10) Pub. No.: US 2025/0220713 A1
(43) Pub. Date: Jul. 3, 2025

(54) Resource Allocation

(71) Applicant: Telefonaktiebolaget LM Ericsson (publ), Stockholm (SE)

(72) Inventors: Hieu Do, Järfälla (SE); Shehzad Ali Ashraf, Munich (DE); Ricardo Blasco Serrano, Espoo (FI); Jose Angel Leon Calvo, Munich (DE)

(21) Appl. No.: 18/853,615

(22) PCT Filed: Mar. 31, 2023
(86) PCT No.: PCT/EP2023/058593

§ 371 Date: Oct. 2, 2024

Related U.S. Application Data
(60) Provisional application No. 63/326,997, filed on Apr. 4, 2022.

(51) Int. Cl. H04W 74/0816; H04W 28/26; H04W 72/02; H04W 72/0446; H04W 92/18

(52) U.S. Cl. CPC H04W 74/0816; H04W 28/26; H04W 72/02; H04W 72/0446; H04W 92/18

(57) ABSTRACT

The present disclosure provides a method performed by a wireless device. A set of candidate transmission resources in a channel for transmission of a transport block (TB) is determined (601). A first transmission resource for transmission of the TB in a first time slot of the channel is selected (603) from the set of candidate transmission resources. Opportunistic transmission of the TB is performed. That is, prior to the first time slot, a channel access procedure in the channel and a resource sensing procedure in the channel is performed (605). In response to the channel access procedure and the resource sensing procedure, it is determined (607) that a second transmission resource in a second time slot of the channel is available for use. The second time slot is earlier in time than the first time slot. The TB is transmitted (609) using the second transmission resource.

### TECHNICAL FIELD

The present disclosure relates to methods for allocating resources and a wireless device configured to perform those methods.

### BACKGROUND

Sidelink (SL) is the name in the third generation partnership project (3GPP) specifications of the interface used for direct communication between devices, which can also be referred to as device-to-device (D2D) communications. This is in comparison to typical cellular communications in which two devices communicate by means of uplink (UL) and downlink (DL) transmissions. The sidelink interface is sometimes referred to as the PC5 interface. The UL/DL interface is sometimes referred to as the Uu interface.

3GPP specified the sidelink (SL) as part of 3GPP Release 12 (Rel-12). The target use case (UC) was Proximity Services (communication and discovery). Support was enhanced during 3GPP Release 13 (Rel-13). In 3GPP Release 14 (Rel-14), the long term evolution (LTE) sidelink was extensively redesigned to support vehicular communications (commonly referred to as vehicle-to-everything (V2X) or vehicle-to-vehicle (V2V) communications). Support was again enhanced during 3GPP Release 15 (Rel-15). From the point of view of the lowest radio layers, the long term evolution sidelink (LTE SL) uses broadcast communication. That is, transmission from a user equipment (UE) targets any receiver that is in range.

In 3GPP Release 16 (Rel-16), 3GPP introduced the sidelink for the fifth generation (5G) new radio (NR). The driving UC was vehicular communications with more stringent requirements than those typically served using the LTE SL. To meet these requirements, the new radio sidelink (NR SL) is capable of broadcast, groupcast, and unicast communications. In groupcast communication, the intended receivers of a message are typically a subset of the vehicles near the transmitter, whereas in unicast communication, there is a single intended receiver. Both the LTE SL and the NR SL can operate with and without network coverage and with varying degrees of interaction between the user equipments (UEs) and the network (NW), including support for standalone, network-less operation.

Radio resources for SL communication are organized into SL resource pools. An NR SL resource pool consists of radio resources spanning both time and frequency domain. In the time domain, the SL resource pool consists of NR slots indexed in an ascending order, starting from index 0 up to a maximum index value. Once this maximum index is reached, the slot indexing is started again from index 0, and so on. In the frequency domain, a resource pool is divided into multiple subchannels (or subbands), each subchannel consisting of a number of contiguous resource blocks. A transmission in the sidelink uses an integer number of subchannels.

There are two resource allocation modes in NR sidelink: Mode 1 and Mode 2. Mode 1 refers to network-scheduled sidelink transmissions, while Mode 2 refers to the scenario in which each UE autonomously selects resources for its sidelink transmissions. In Mode 1, a gNodeB (gNB) schedules a UE via dynamic grants or configured grants.

Mode 2 resource allocation is based on sensing of radio resources. A resource selection protocol performed by a UE comprises three parts: sensing within a sensing window, excluding resources reserved by other UEs to find a set of candidate resources, and selecting the transmission resources among the candidate resources within a selection window. Note that resources for transmissions are selected from a set of candidate resources in a random manner, with some extra condition on the minimum time interval between two consecutive selected resources. Additionally, shortly before transmitting in a reserved resource, the UE can re-evaluate the set of reserved resources to take into account the latest status of resource usage (e.g., some of the resources might have been occupied by aperiodic transmission after the resource reservation). If the reserved resources would not be part of the set for selection at this time, then new resources are selected from an updated resource selection window. In addition to the re-evaluation, pre-emption is also introduced such that a UE selects new resources even after it announces the resource reservation when it observes resource collision with a higher priority transmission from another UE.

Resource sensing is performed by decoding the sidelink control information (SCI) sent by other UEs and measuring the received power (e.g., reference signal received power (RSRP)) at the resource blocks of interest, thereby enabling the exclusion of resources reserved by other UEs. The sensing window is a time window which ends shortly before the resource selection is triggered. The selection window starts shortly after the trigger for resource (re-)selection and cannot be longer than the remaining latency budget (also known as packet delay budget (PDB)) of the packet to be transmitted. The procedure for resource selection and resource reselection are the same.

FIG. 1 illustrates the timeline of a sensing window 105 and a selection window 133. The former consists of SL slots in the period of [n−T0, n−Tproc,0] and the latter consists of SL slots in the periods of [n+T1, n+T2] where n is the time at which the resource allocation is triggered. T0, T1, T2 and Tproc,0 are (pre-)configured values satisfying various conditions. The resource re-evaluation can happen at time m−T3 at the latest, where T3 is 2 milliseconds.

As described above, when a resource selection is triggered, the UE will select resources for its transmissions. In NR SL 3GPP Rel-16, the UE is allowed to select multiple resources (up to 32). In each transmission, the UE can signal to other UEs its reservation of up to two additional resources in the near future and potentially a reservation for periodic transmissions using the same frequency resources in the further future. Note that this means the UE can internally select more resources than it can reserve. A UE may reserve a time slot by transmitting sidelink control information (SCI) indicating the reservation at the beginning of a time slot. When the channel being used for sidelink transmission is a shared spectrum channel, such as an unlicensed channel, the UE must first perform a channel access procedure prior to transmitting in a reserved time slot to ensure that the channel is available for use.

FIG. 1 illustrates the case in which, by the transmission at a first selected resource at time m, the UE reserves resources for two additional transmissions. Typically, when the UE performs resource selection, the first selected resource is for the initial transmission of a packet and the additional reserved resources are for the retransmissions of the same packet. The resource re-evaluation and pre-emption described earlier allows a UE to reselect a selected resource if the UE detects that the selected resource (can be reserved or not-yet-reserved) is occupied by some other UEs with higher priority.

In 3GPP Release 17 (Rel-17), 3GPP has developed partial sensing schemes for sidelink. In partial sensing, the UE is not required to sense for the full sensing window as in 3GPP Rel-16, thereby reducing power consumption. The present disclosure is applicable to both full sensing (per 3GPP Rel-16) and partial sensing (per 3GPP Rel-17).

The 5G NR supports performing uplink and downlink transmissions in unlicensed spectrum since 3GPP Rel-16. The unlicensed spectrum can be used by any device as long as certain rules for using the channel are met. These rules are often set by regulatory bodies in different parts of the world. In the unlicensed spectrum, the transmission medium (i.e., the channel) is shared by multiple users. To avoid conflicts and collisions of transmissions, channel access procedures are defined. The channel access procedure typically involves the following steps: (1) Sensing the channel for a certain period to detect whether other equipment (e.g., device, network node, etc.) are transmitting. This is sometimes referred to as performing clear channel assessment (CCA). (2) If the channel is sensed as busy (i.e., CCA was unsuccessful or failed), the transmitter does not transmit. (3) If the channel is sensed as idle (i.e., CCA was successful), the transmitter makes use of the channel (e.g., transmits the information or signals, etc.).

The channel is utilized for a certain time, referred to as the channel occupancy time (COT). In some cases, different equipment may share a COT.

In 3GPP Release 18 (Rel-18), 3GPP is going to develop mechanisms that enable the operation of SL communications in unlicensed spectrum, sometimes referred to as SL-U. It is expected that SL-U design will take NR SL and NR communications in the unlicensed spectrum, sometimes referred to as NR-U, designs as baseline.

In cellular systems, the network typically configures some parameters used by the UEs. This configuration is typically signaled by a NW node (e.g., a gNB) to the UE (e.g., using radio resource configuration (RRC) signaling, broadcast signaling such as master information block (MIB) or system information block (SIB), or some other type of signaling). This is applicable to UEs performing sidelink transmissions if they are in coverage of a network. UEs that are out of network coverage but participate in sidelink communications, may be provided the corresponding parameters by means of a pre-configuration (e.g., stored in the subscriber identity module (SIM)). Unless explicitly stated, the terms configuration, pre-configuration, or (pre-)configuration are used to denote both ways of providing the corresponding configuration/parameters to a UE.

### SUMMARY

There currently exist certain challenge(s). The resource allocation procedure for SL was designed primarily for SL operation in dedicated resources, i.e., resources used solely by SL devices. However, this is not the case in the unlicensed spectrum, where several problems may arise.

First, a UE typically needs to perform a channel access procedure (e.g., listen-before-talk (LBT)) before each SL transmission. One problem arises when a UE has selected a resource for a transmission, but the UE cannot perform the transmission due to a channel access failure (e.g., the channel is already occupied by a Wi-Fi transmission). This may happen to both an initial transmission and the retransmissions of a TB. A straightforward solution may be selecting a new resource and making a new attempt to transmit, but that not only increases the delay but there is again no guarantee that the channel is idle (e.g., the channel will not be occupied by a Wi-Fi transmission) when it is time for the re-attempt of transmission on the newly selected resource.

Another problem arises due to the random selection of resources in the set of candidate resources identified by the SL sensing process. Due to this behavior, the resources selected by the same UE as well as by different UEs will scatter in the system resources (both in time and frequency). This resource fragmentation is undesirable for several reasons. A UE which wants to select a large chunk of resources will be unlikely to find one. Also, due to the typical LBT-based channel access (i.e., based on energy detection) rules in unlicensed bands, even if only one part of the channel bandwidth is utilized, the whole channel can be perceived as busy by a device performing CCA. As a result, the channel access of the device performing CCA is unnecessarily delayed.

This can be seen in FIG. 2 wherein a UE selects three resources (at slots n+TA 205, n+TB 207, and n+TC 209) randomly based on the set of idle resources identified by the sensing process. As a result, even though only half of the channel bandwidth is occupied at slots n+TA 205, n+TB 207, and n+TC 209, the whole channel can be considered busy in these slots, precluding the decrementing of the LBT counter at other UEs during these slots.

It is an object of the disclosure to obviate or eliminate at least some of the above-described disadvantages associated with existing techniques.

According to a first aspect of the present disclosure, there is provided a method performed by a wireless device. The method comprises determining a set of candidate transmission resources in a channel for transmission of a transport block (TB). The method comprises selecting, from the set of candidate transmission resources, a first transmission resource for transmission of the TB in a first time slot of the channel, and performing opportunistic transmission of the TB. Performing opportunistic transmission of the TB comprises, prior to the first time slot, performing a first channel access procedure in the channel and a first resource sensing procedure in the channel. Performing opportunistic transmission of the TB comprises determining, in response to the first channel access procedure and the first resource sensing procedure, that a second transmission resource in a second time slot of the channel is available for use, and transmitting the TB using the second transmission resource. The second time slot is earlier in time than the first time slot. According to a second aspect of the present disclosure, there is provided a wireless

device configured to perform operations according to the first aspect. In some embodiments, the wireless device may comprise processing circuitry configured to operate in accordance with the above-described first aspect. In some embodiments, the wireless device may comprise a memory coupled to the processing circuitry. The memory may comprise computer program instructions that, when executed by the processing circuitry, cause the wireless device to perform operations according to the above-described first aspect.

According to a third aspect of the present disclosure, there is provided a computer program comprising instructions which, when executed by processing circuitry, cause the processing circuitry to perform the method according to the first aspect.

According to a fourth aspect of the present disclosure, there is provided a computer program product, embodied on a non-transitory machine-readable medium, comprising instructions which are executable by processing circuitry to cause the processing circuitry to perform the method according to the first aspect.

Certain aspects of the disclosure and their embodiments can provide solutions to the above-mentioned problems, or other challenges. Such solutions include, for example, a mechanism that allows a wireless device (or UE) to perform an early SL transmission when it is allowed to do so by the channel access mechanism and by the SL resource selection protocol, a method to select resources to reduce the bandwidth fragmentation, and a new resource re-selection trigger based on channel access failure. Some embodiments provide a way to adapt the SL resource selection procedure to take advantage of opportunistically available transmission opportunities. Furthermore, a channel access failure may be considered as a new trigger for resource re-selection according to some embodiments.

Certain embodiments may provide one or more technical advantages, such as alleviating the impacts of channel access failure on SL transmissions by means of opportunistic transmissions, reducing or minimizing the negative impacts of bandwidth fragmentation on the channel access delay, and incorporating the impact of channel access failure into the existing framework of SL resource re-selection.

### BRIEF DESCRIPTION OF THE DRAWINGS

For a better understanding of the techniques, and to show how they may be put into effect, reference will now be made, by way of example, to the accompanying drawings, in which:

FIG. 1 is an example illustration of a timeline of a sensing window and a selection window;

FIGS. 2-5 are example illustrations of resource allocation;

FIGS. 6-8 are flowcharts illustrating a method performed by a wireless device according to some embodiments;

FIG. 9 is a block diagram illustrating a system according to an embodiment;

FIG. 10 is a block diagram illustrating a user equipment according to an embodiment;

FIG. 11 is a block diagram illustrating a network node according to an embodiment;

FIG. 12 is a block diagram illustrating a host computer according to an embodiment;

FIG. 13 is a block diagram illustrating a virtualization environment according to an embodiment; and

FIG. 14 is a block diagram illustrating a host computer communicating via a network node with a user equipment according to an embodiment.

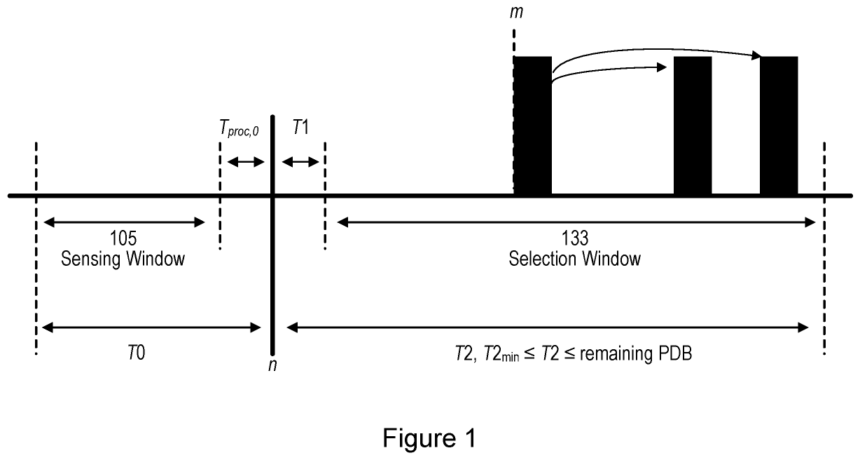

### DETAILED DESCRIPTION

Some of the embodiments contemplated herein will now be described more fully with reference to the accompanying drawings. Embodiments are provided by way of example to convey the scope of the subject matter to those skilled in the art.

Described herein is a method for allocating (or selecting) resources for sidelink transmissions. The method includes steps for selecting resources for a transmission, which potentially also reserves resources for one or more subsequent transmissions (e.g., retransmissions of the same transport block (TB)). The methods presented herein can, for example, be applied to both SL operation in unlicensed spectrum as well as in licensed or dedicated spectrum.

The following terminology is used herein:
TX UE: this is the UE transmitting one or more TBs to a RX UE (or multiple RX UEs) along with control signaling. These messages may be carried by a physical sidelink shared channel (PSSCH) and/or a physical sidelink control channel (PSCCH).
RX UE: this is the UE receiving the transmission. Based on this reception, the RX UE can provide SL hybrid automatic repeat request (HARQ) feedback (FB) to the TX UE. The SL HARQ FB may be carried by a physical sidelink feedback channel (PSFCH). The SL HARQ FB may be a HARQ acknowledgement (HARQ-ACK) or a HARQ negative acknowledgement (HARQ-NACK), or some other indication. The technique can be extended to multiple RX UEs. The multiple RX UEs may provide feedback using independent resources or using a common resource. In the latter case, the TX UE may observe a superposition of the transmissions by the multiple RX UEs.
A channel access procedure can be a procedure (e.g. based on sensing) that evaluates the availability of a channel for performing transmissions. For shared channel or spectrum, this procedure typically requires a UE to perform LBT (e.g. based on energy detection) such as the mechanisms defined in the 3GPP technical standard (TS) 37.213, to determine whether the UE is allowed to use the channel for a transmission. A resource sensing procedure can be a procedure to sense resources, e.g. in a channel.
A slot or time slot denotes the unit of a time resource, but the idea can be applicable to other time resource units like subframe, frame, mini slot, etc.

A UE may perform sensing and resource selection, based on the same version or a modified version of the resource selection procedures specified in SL 3GPP Rel-16 or 3GPP Rel-17, to select resources for an initial transmission and possibly some retransmissions of a TB. Additionally, before a first time slot where a transmission is supposed to occur based on the resources selected above, if the UE is able to gain a channel access at a second time slot, and a resource on the second time slot can be selected for the transmission based on a sensing operation, the UE may select the resource and use it for the transmission. This is called an opportunistic transmission. Otherwise, the UE waits until the originally selected resource on the first time slot to transmit. A UE can also be referred to herein as a wireless device.

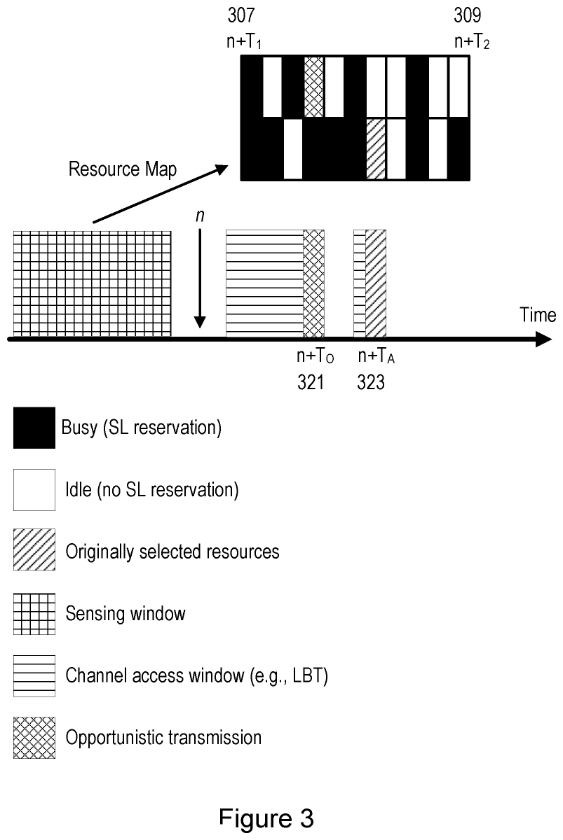

FIG. 3 illustrates a procedure for selecting a resource according to an embodiment. As illustrated in FIG. 3, in one embodiment of the present disclosure, in a TX UE at slot t=n, a resource selection can be triggered in the UE for the transmission of a TB. The UE determines a set of candidate resources (e.g. by a resource sensing procedure). The UE selects a resource for transmission (at slot n+T_{A}) from the set of candidate resources.

At slot n+T_{O}, where T_{O}<T_{A}, the UE may update the set of candidate resources based on received SL transmissions (i.e., the UE may continue to sense SCI during a selection window and update the set of candidate resources) if (1) the UE has completed a channel access procedure (as defined above) (i.e., the LBT counter is at zero and the channel is free) which indicates that the UE is allowed to transmit in slot n+T_{O}; and (2) there is at least one resource in the set of candidate resources in the slot n+T_{O}. Then, the UE selects a resource in slot n+T_{O} from the set of candidate resources and uses it for transmission.

At slot t=n+T_{A}, if: (1) the UE has data to transmit; and (2) the UE has completed an LBT channel access procedure that indicates that the UE is allowed to transmit at time n+T_{A}, the UE may use the resource originally selected at slot n+T_{A} for transmission.

In the example illustrated in FIG. 3, the UE may perform a sensing procedure as in 3GPP Rel-16, which produces a set of candidate resources denoted as “Idle” in the resource map between slots n+T₁ 307 and n+T₂ 309 (the resource selection window). The UE then selects a resource at slot n+T_{A} 323 for its transmission. Prior to slot n+T_{A}, the UE performs a channel access procedure (as defined above). The UE may also update the set of candidate resources based on newly received SL control and data transmissions. If the channel access procedure indicates that the UE is allowed to transmit in slot n+T_{O} 321 (where T_{O}<T_{A}) and there is a candidate resource in slot n+T_{O} 321, the UE can select the resource and transmit in slot n+T_{O} 321. The transmission at slot n+T_{O} is termed an “opportunistic transmission” in this disclosure.

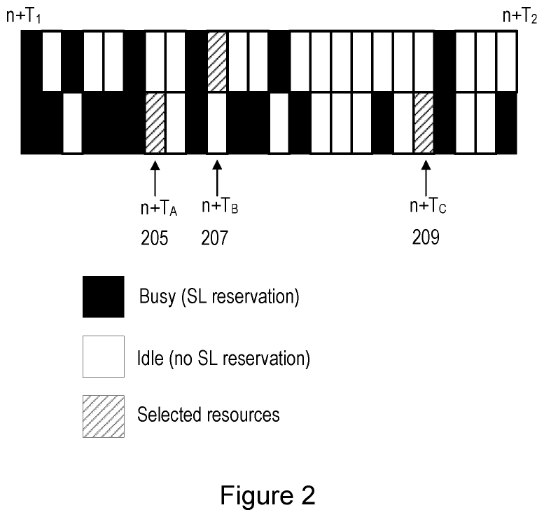

In one embodiment, only the initial transmission of a TB can be an opportunistic transmission. For example, in the example of FIG. 2, the opportunistic transmission can only happen at n+T_{O}<n+T_{A} 205.

In one embodiment, any transmission of a TB (i.e., either an initial transmission or a retransmission) can be an opportunistic transmission. For example, in the example of FIG. 2, the opportunistic transmission can happen at n+T_{O}<n+T_{B} 207 or n+T_{C} 209.

In one embodiment, the opportunistic transmission may only happen if the time gap to the next originally selected resource is equal to or larger than a threshold. For example, in the example in FIG. 3, the opportunistic transmission may only be allowed if the time gap between n+T_{A} 323 and n+T_{O} 321 is equal to or larger than a predefined or a (pre-)configured duration. This provides the UE enough time to determine channel access at n+T_{A} and get HARQ feedback to determine whether or not to retransmit the TB.

In one embodiment, an opportunistic transmission can be performed under a condition, e.g., responsive to a congestion level (as measured by the UE) being above or below a certain threshold and/or a priority level associated with the TB, to be transmitted, being below a certain threshold and/or an indication (e.g., from a network node) indicating the absence of non-SL devices. As will be appreciated, in some embodiments, “below a certain threshold” can mean that the transmission has a higher priority level, as a priority of 1 has the highest priority, with higher numbers having a lower priority.

In one embodiment, if the UE performs an opportunistic transmission, the UE may perform no further opportunistic transmission at least until n+T_{A}. In one embodiment, the UE may abstain from performing a transmission which is

preceded by an opportunistic transmission. That means, in the procedure above, the UE may not perform the transmission at slot n+T_{A} if an opportunistic transmission already occurred at slot n+T_{O} (T_{O}<T_{A}).

In one embodiment, the sensing (to determine the set of candidate resources) and resource selection procedure can be the sensing and selection procedure specified in NR SL 3GPP Rel-16 and 3GPP Rel-17.

In one embodiment, if multiple resources in slot n+T_{O} (i.e., in multiple subchannels) are contained in the set of candidate resources, the UE may select one at random.

In one embodiment, the UE may select resources from the set of candidate resources identified by the sensing in such a way that the bandwidth (BW) fragmentation is minimized. For example, at least one of the following can be performed: (1) the UE selects resources such that the number of slots with a single occupied subchannel is minimized; or (2) the UE selects resources such that the number of slots with all subchannels being occupied is maximized. For example, to minimize BW fragmentation, the UE may prioritize selection of transmit resources in slots that already have a reserved subchannel.

In one embodiment, the resource selection to minimize BW fragmentation may not be applicable to an opportunistic transmission.

In one embodiment, if an opportunistic transmission happens, the UE may re-select the selected resources occurring after the opportunistic transmission to minimize BW fragmentation as described above.

In one embodiment, the UE may select resources from the set of candidate resources identified by the sensing in such a way that the time interval between two consecutive selected resources is doubled for every new selected resource. For example, if four resources are selected at time n+T_{A}, n+T_{B}, n+T_{C}, n+T_{D}, where T_{A}<T_{B}<T_{C}<T_{D}, then T_{D}−T_{C}=2*(T_{C}−T_{B})=4*(T_{B}−T_{A}). This is to cater for the potential doubling of the contention window when a retransmission is needed, which is typically required by LBT rules (e.g., because the contention window is doubled after a NACK, which indicates need for retransmission). This doubling of the interval length is applicable to any SCI that reserves resources for retransmissions (not just the SCI of the opportunistic transmission). In particular, it can apply to the SCI of the transmission at T_{A} in case there is no opportunistic transmission.

In one embodiment, to update the set of candidate resources, the UE can use a different parameter than that of the sensing procedure. For example, a new RSRP threshold may be applied to determine idle resources in slot n+T_{O}.

In one embodiment, the opportunistic transmission can reserve resources for one or more retransmissions of the same TB and/or for a transmission of a new TB.

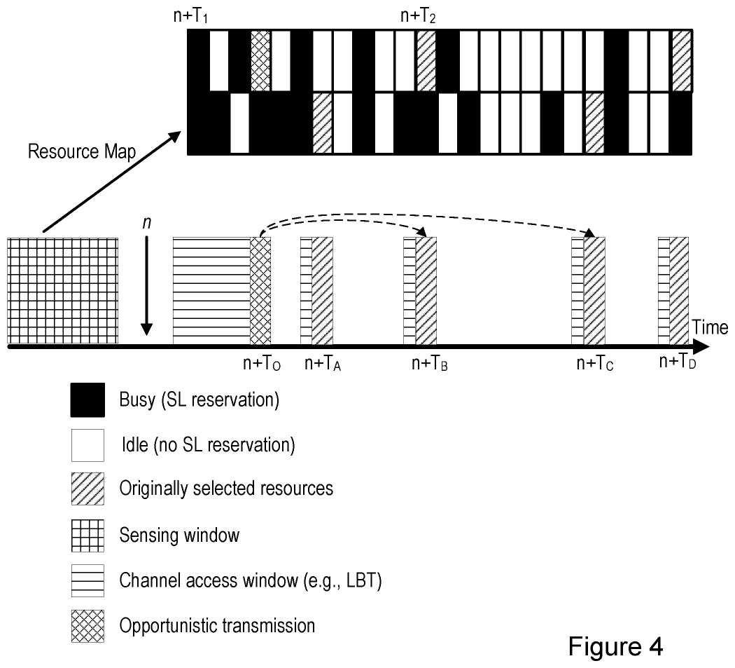

In one embodiment, the resources reserved by an opportunistic transmission can be the same as the resources that would have been reserved by the transmission preceded by the opportunistic transmission. For example, as illustrated in FIG. 4, in some embodiments, the opportunistic transmission at n+T_{O} may reserve resources for future transmissions of the same TB at time n+T_{B} and n+T_{C}, which are the same resources to be reserved by the transmission originally planned at n+T_{A}.

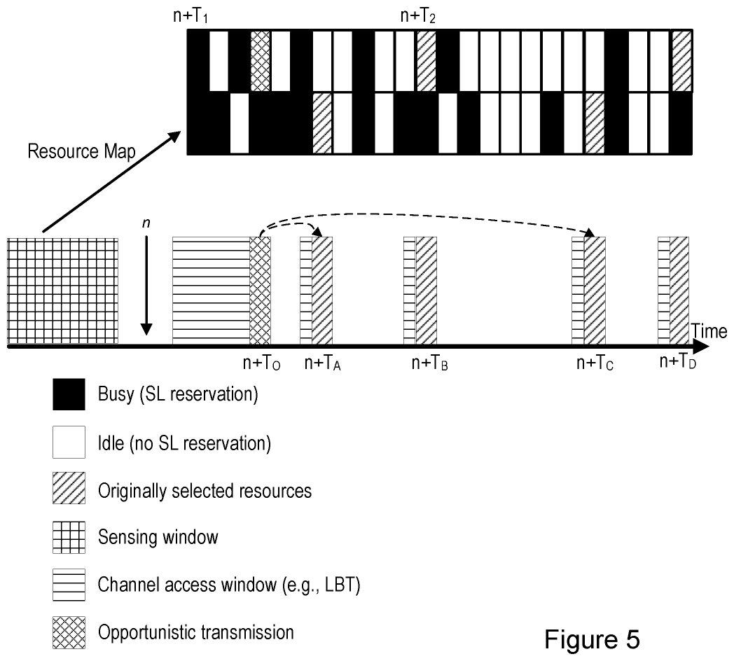

In one embodiment, the resources reserved by an opportunistic transmission may include the resource of the transmission which is preceded by the opportunistic transmission. For example, as illustrated in FIG. 5, in some embodiments, the opportunistic transmission at n+T_{O} may reserve resources for future transmissions of the same TB at slot n+T_{A} and n+T_{B} or at slot n+T_{A} and n+T_{C}.

In another embodiment, the resources reserved by an opportunistic transmission can be in contiguous sub-bands (of the same slot) with the sub-bands of the resources reserved by the transmission which is preceded by the opportunistic transmission. For example, in case an opportunistic transmission at n+T_{O} precedes a non-opportunistic transmission at n+T_{A}, and both these transmissions reserve resources at a slot n+T_{B} (where T_{O}<T_{A}<T_{B}), all the reserved resources in slot n+T_{B} are in contiguous sub-bands. This is to minimize the bandwidth fragmentation.

In one embodiment, the resources reserved by an opportunistic transmission can be newly selected resources.

In one embodiment, the resource selection can be triggered by at least one of the following: (1) a packet arrival; (2) the outcome of a resource re-evaluation or pre-emption (higher priority) as defined in legacy operation of SL; or (3) due to failed channel access by the UE. For example, if the UE has selected a resource to transmit at slot K but the channel access procedure indicates that the UE is not allowed to transmit at slot K, the UE needs to reselect a new resource.

Therefore, there are provided methods for allocating resources. The methods can be useful in a variety of use cases. For example, the methods can be provided for allocating resources for sidelink, such as sidelink in an unlicensed spectrum. The methods described herein can be performed by a wireless device, which may also be referred to herein as a UE.

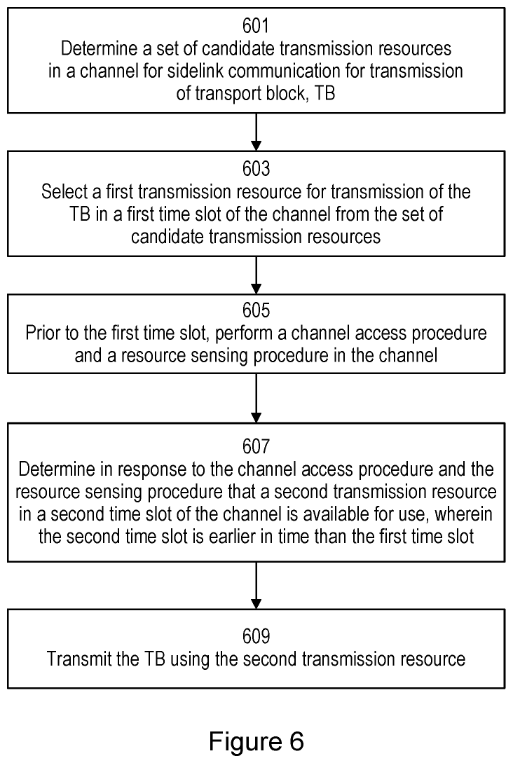

Operations of a wireless device according to some embodiments are illustrated in FIGS. 6, 7 and 8.

Referring to FIG. 6, a method performed by a wireless device includes determining a set of candidate transmission resources in a channel for transmission of a TB (block 601 of FIG. 6), selecting a first transmission resource for transmission of the TB in a first time slot of the channel from the set of candidate transmission resources (block 603 of FIG. 6), and performing opportunistic transmission of the TB. Performing opportunistic transmission of the TB includes, prior to the first time slot, performing a channel access procedure in the channel and a resource sensing procedure in the channel (block 605 of FIG. 6), determining, in response to the channel access procedure and the resource sensing procedure, that a second transmission resource in a second time slot of the channel is available for use, wherein the second time slot is earlier in time than the first time slot (block 607 of FIG. 6), and transmitting the TB using the second transmission resource (block 609 of FIG. 6).

In some embodiments, determining that the second transmission resource is available may comprise determining that the channel is clear based on the channel access procedure, and determining based on the resource sensing procedure that the second transmission resource has not been reserved by another device.

In some embodiments, the second time slot may belong to the set of candidate resources.

In some embodiments, the method may further include, after performing the resource selection, receiving a sidelink transmission in the channel, and updating the set of candidate transmission resources based on a resource reservation contained in the received sidelink transmission.

In some embodiments, the resource reservations can be contained in sidelink control information (SCI) contained in the received sidelink transmission.

In some embodiments, determining that the second transmission resource is available for use may include determining that the second transmission resource has not been reserved by another device based on the updated set of candidate transmission resources.

In some embodiments, determining that the second transmission resource is available for use can be based on a reference signal received power (RSRP) measurement in the channel.

In some embodiments, determining the set of candidate transmission resources may comprise comparing a RSRP measurement of the channel to a first threshold, and updating the set of candidate transmission resources comprises comparing a RSRP measurement of the channel to a second threshold, wherein the first threshold is different from the second threshold.

In some embodiments, the opportunistic transmission may be performed only if a time gap between the second time slot and the first time slot is greater than a threshold value.

In some embodiments, the threshold value can be selected to be large enough for the wireless device to receive feedback from the opportunistic transmission before the first time slot.

In some embodiments, the method may further include determining that a condition has been fulfilled, and performing the opportunistic transmission in response to fulfillment of the condition. The condition may include one or more of: a congestion level of the channel being above a predetermined threshold level, the congestion level of the channel being below the predetermined threshold level, a priority level of the TB being above a predetermined threshold level, a priority level of the TB being below a predetermined threshold level, and/or an indication from a network node indicating absence of non-sidelink devices using the channel.

In some embodiments, the method may further include, after performing the opportunistic transmission and/or an opportunistic retransmission, refraining from performing a subsequent opportunistic transmission for a predetermined time period. For example, after performing the opportunistic transmission or retransmission, the wireless device may refrain from performing a subsequent opportunistic transmission until after the first time slot.

In some embodiments, following the opportunistic transmission using the second transmission resource in the second time slot, the wireless device may refrain from transmitting using the first transmission resource in the first time slot.

In some embodiments, selecting the first transmission resource may comprise selecting the first transmission resource at random from the set of candidate transmission resources.

In some embodiments, selecting the first transmission resource may comprise selecting the first transmission resource to reduce bandwidth fragmentation of the channel. For example, the wireless device may select the first transmission resource such that a number of time slots within the selection window having a single occupied subchannel following selection of the first transmission resource is minimized and/or such that a number of time slots within the selection window having all subchannels occupied following selection of the first transmission resource is maximized.

In some embodiments, selecting the first transmission resource to reduce bandwidth fragmentation of the channel may include selecting a resource in a slot for which a previously received reservation has reserved another resource.

In some embodiments, selecting the first transmission resource to reduce bandwidth fragmentation of the channel may include assigning a higher probability of selection to resources in a slot for which a previously received reservation has reserved another resource compared to resources in a slot for which for which no previously received reservation has reserved another resource.

In some embodiments, selecting the first transmission resource to reduce bandwidth fragmentation of the channel may include comparing a lower RSRP threshold to RSRP measurements associated with resources in a slot for which a previously received reservation has reserved another resource compared to resources in a slot for which no previously received reservation has reserved another resource.

In some embodiments, performing the channel access procedure may comprise sensing a subchannel of the channel, the subchannel containing the second transmission resource, within a channel access window prior to the first time slot.

In some embodiments, performing resource selection of transmission resources may comprise sensing the channel within a sensing window, wherein the set of candidate transmission resources falls within a selection window that is later in time than the sensing window.

In some embodiments, the method may further include, after the opportunistic transmission, re-selecting transmission resources to reduce bandwidth fragmentation of the channel.

In some embodiments, the opportunistic transmission may comprise sidelink control information (SCI) that reserves an additional transmission resource for retransmission of the TB or transmission of a new TB.

The SCI may reserve a plurality of subsequent transmission resources in subsequent time slots for retransmission of the TB, wherein time intervals between successive subsequent time slots for retransmissions are increased compared to previous time intervals between successive subsequent time slots for retransmissions. For example, the time intervals between successive subsequent time slots for retransmissions may be doubled compared to previous time intervals between successive subsequent time slots for retransmissions.

In some embodiments, the additional transmission resource reserved by the opportunistic transmission may be later in time than the first time slot.

The additional transmission resource reserved by the opportunistic transmission may include the first transmission resource or a newly selected transmission resource. In some embodiments, the additional transmission resource reserved by the opportunistic transmission may be selected from the set of candidate transmission resources.

In some embodiments, the method may further include transmitting SCI in the first transmission resource that reserves a third transmission resource for retransmission in a third time slot, wherein the additional transmission resource is in a first subchannel of the third time slot that is contiguous with a second subchannel containing the third transmission resource.

In some embodiments, the method may further include determining that a plurality of transmission resources are available in the second time slot, and randomly selecting one of the plurality of transmission resources that are available in the second time slot for transmitting the TB in the second time slot.

In some embodiments, the channel may include a shared spectrum channel, such as an unlicensed channel.

In some embodiments, performing the resource selection may be triggered by the wireless device failing to access a channel for the TB.

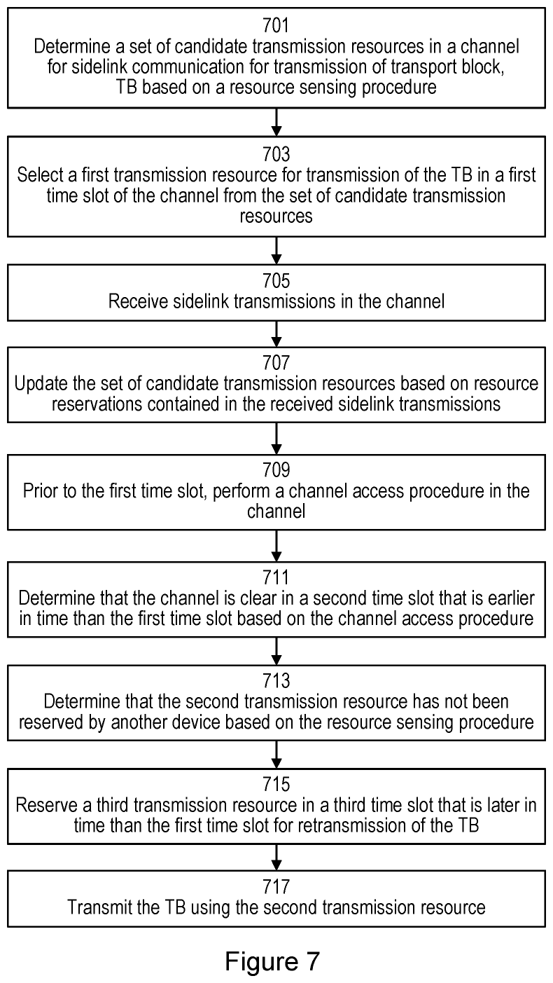

In some embodiments, the method may further include reserving the first transmission resource for transmission of the TB, and reserving a third transmission resource in a third time slot that is later in time than the first time slot for retransmission of the TB. For example, as shown in FIG. 7, a method performed by a wireless device according to some embodiments includes determining a set of candidate transmission resources in the channel for transmission of a TB (block 701 of FIG. 7), and selecting a first transmission resource for transmission of the TB in a first time slot of the channel from the set of candidate transmission resources (block 703 of FIG. 7). The wireless device may then receive sidelink transmissions in the channel (block 705 of FIG. 7). The wireless device may update the set of candidate transmission resources based on resource reservations contained in the received sidelink transmissions (block 707 of FIG. 7).

The wireless device then performs opportunistic transmission of the TB, where performing opportunistic transmission of the TB includes, prior to the first time slot, performing a channel access procedure in the channel and a resource sensing procedure in the channel (block 709 of FIG. 7), determining, in response to the channel access procedure and the resource sensing procedure, that a second transmission resource in a second time slot of the channel is available for use, wherein the second time slot is earlier in time than the first time slot (block 711 of FIG. 7). The wireless device further determines based on the updated set of candidate transmission resources that the second transmission resource has not been reserved by another device (block 713 of FIG. 7). The wireless device may reserve a third transmission resource in a third time slot that is later than the first time slot for retransmission of the TB (block 715 of FIG. 7), and then transmit the TB using the second transmission resource (block 717 of FIG. 7).

In some embodiments, the method may further include performing opportunistic retransmission of the TB, wherein performing opportunistic retransmission of the TB includes, after the first time slot, performing a second channel access procedure in the channel and a second resource sensing procedure in the channel, determining, in response to the second channel access procedure and the second resource sensing procedure, that a fourth transmission resource in a fourth time slot of the channel is available for use, wherein the fourth time slot is earlier in time than the third time slot, and retransmitting the TB using the fourth transmission resource.

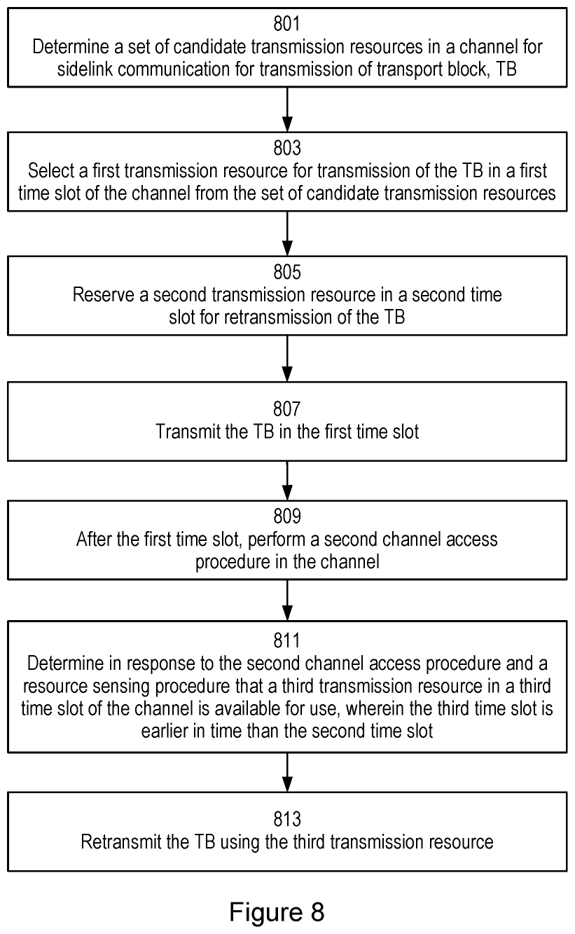

FIG. 8 illustrates an example embodiment in which an opportunistic retransmission is performed. Referring to FIG. 8, a method performed by a wireless device according to some embodiments includes determining a set of candidate transmission resources in the channel for transmission of a TB (block 801 of FIG. 8), and selecting a first transmission resource for transmission of the TB in a first time slot of the channel from the set of candidate transmission resources (block 803 of FIG. 8). In some embodiments, the wireless device may reserve transmission resources in a second time slot for retransmission of the TB (block 805 of FIG. 8) and transmit the TB in the first time slot. In some embodiments, the wireless device may transmit the TB in the first time slot (block 807 of FIG. 8).

In some embodiments, after transmitting the TB, the wireless device may perform a second channel access procedure in the channel (block 809 of FIG. 8). In some embodiments, the wireless device may determine that a third transmission resource in a third time slot, that is earlier in time than the second time slot, is available for use (block 811 of FIG. 8). In some embodiments, the wireless device may then perform opportunistic retransmission of the TB using the third transmission resource in the third time slot (block 813 of FIG. 8).

In some embodiments, opportunistic retransmission may be performed only if a time gap between the second time slot and the third time slot is greater than a threshold value.

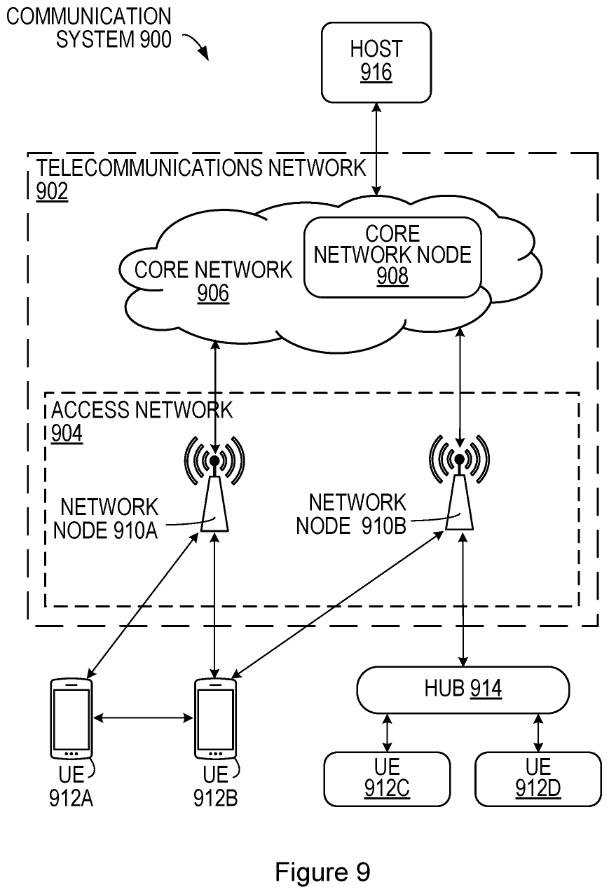

FIG. 9 shows an example of a communication system 900 in accordance with some embodiments.

In the example, the communication system 900 includes a telecommunications network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar third Generation Partnership Project (3GPP) access node or non-3GPP access point. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunications network 902 to enable and/or provide network access, such as wireless network access, and/or to perform other functions, such as administration in the telecommunications network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunications network 902, and may be operated by the service provider or on behalf of the service provider. The host 916 may host a variety of applications to provide one or more services. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable second generation (2G), 3G, fourth generation (4G), fifth generation (5G) standards, or any applicable future generation standard (e.g., sixth generation (6G)); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC), ZigBee, LiFi, and/or any low-power wide-area network (LPWAN) standards such as LoRa and Sigfox.

In some examples, the telecommunications network 902 is a cellular network that implements 3GPP standardized features. Accordingly, the telecommunications network 902 may support network slicing to provide different logical networks to different devices that are connected to the telecommunications network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive internet of things (IoT) services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-radio access technology (RAT) or multi-standard mode. For example, a UE may operate with any one or combination of Wi-Fi, NR (New Radio) and LTE, i.e. being configured for multi-radio dual connectivity (MR-DC), such as Evolved-UMTS Terrestrial Radio Access Network (E-UTRAN) New Radio-Dual Connectivity (EN-DC).

In the example illustrated in FIG. 9, the hub 914 can communicate with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a virtual reality (VR) headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to a machine-to-machine (M2M) service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub-that is, a hub whose primary function is to route communications to/from the UEs from/to the network node 910b. In other embodiments, the hub 914 may be a non-dedicated hub-that is, a device which is capable of operating to route communications between the UEs and network node 910b, but which is additionally capable of operating as a communication start and/or end point for certain data channels.

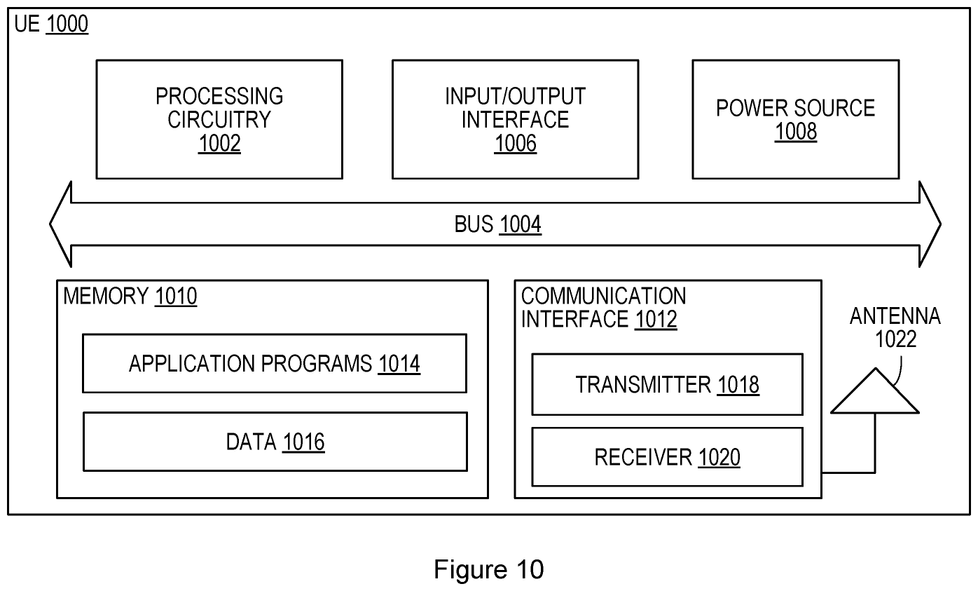

FIG. 10 shows a UE 1000 in accordance with some embodiments. As used herein, a UE refers to a device capable, configured, arranged and/or operable to communicate wirelessly with network nodes and/or other UEs. As such, a UE can be referred to herein as a wireless device and vice-versa. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the third Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V) communication, vehicle-to-infrastructure (V2I) communication, or vehicle-to-everything (V2X) communication. In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a universal SIM (USIM) and/or internet protocol (IP) multimedia SIM (ISIM), other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment of FIG. 10, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), Quick UDP (User Datagram Protocol) Internet Connections (QUIC), Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a television (TV), a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

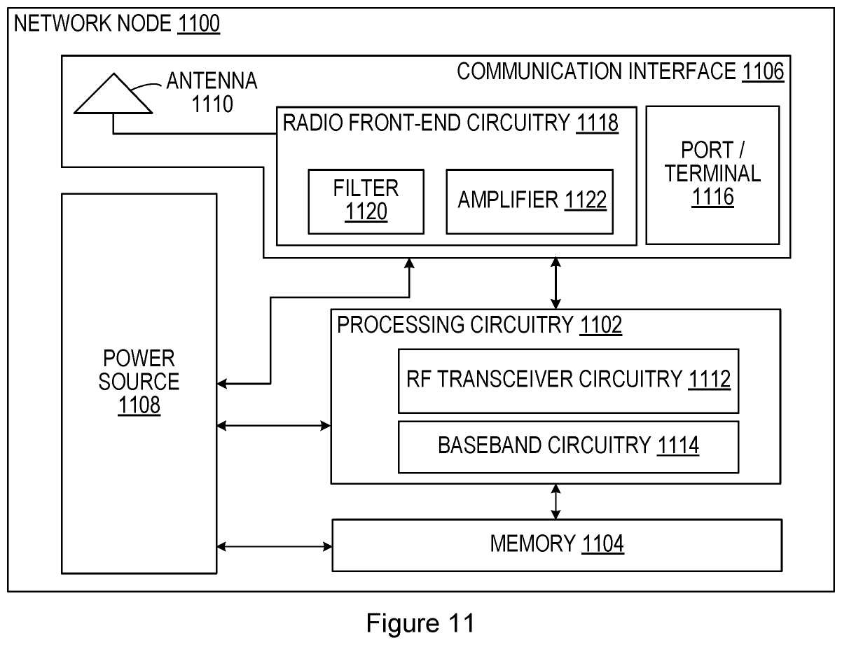

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunications network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and an RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

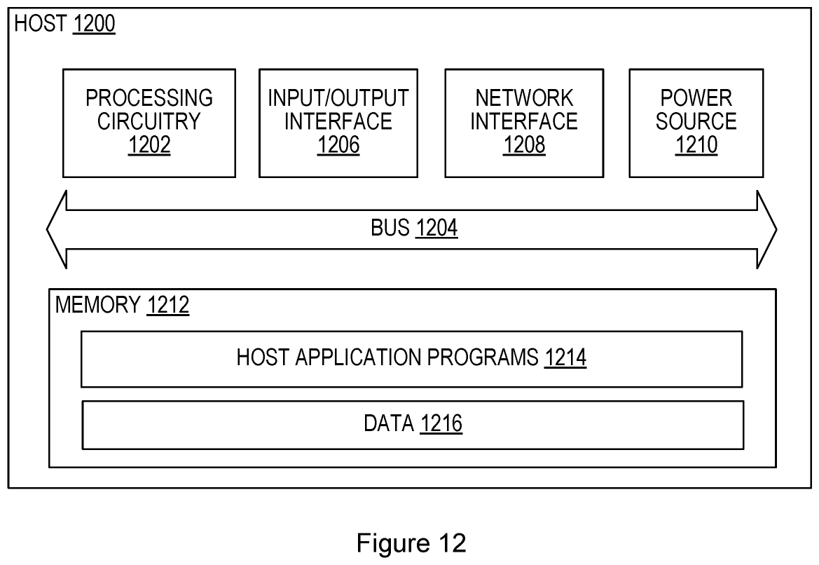

FIG. 12 is a block diagram of a host 1200, which may be an embodiment of the host 916 of FIG. 9, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), moving picture experts group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

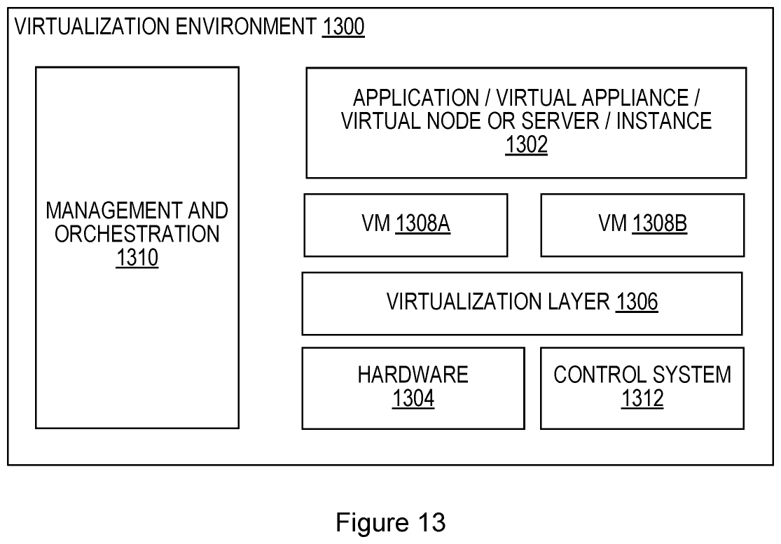

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment 1300 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

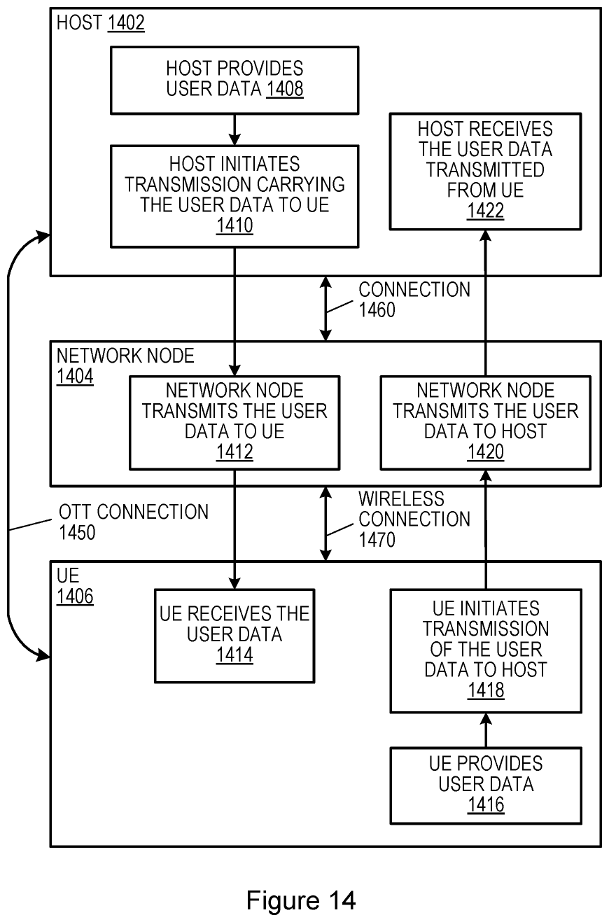

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above, or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

Other embodiments of the present disclosure are defined in the following numbered statements:
Statement 1. A method performed by a wireless device, comprising:
determining a set of candidate transmission resources in the channel for transmission of a transport block, TB;
selecting a first transmission resource for transmission of the TB in a first time slot of the channel from the set of candidate transmission resources; and
performing opportunistic transmission of the TB, wherein performing opportunistic transmission of the TB comprises:
prior to the first time slot, performing a channel access procedure in the channel and a resource sensing procedure in the channel;
determining, in response to the channel access procedure and the resource sensing procedure, that a second transmission resource in a second time slot of the channel is available for use, wherein the second time slot is earlier in time than the first time slot; and
transmitting the TB using the second transmission resource.
Statement 2. The method of Statement 1, wherein determining that the second transmission resource is available comprises determining that the channel is clear based on the channel access procedure, and determining that the second transmission resource has not been reserved by another device based on the resource sensing procedure.
Statement 3. The method of Statement 1, further comprising selecting a resource in the second time slot, wherein the selected resource in the second time slot belongs to the set of candidate resources.
Statement 4. The method of Statement 2, further comprising:
after performing the resource selection, receiving a sidelink transmission in the channel; and
updating the set of candidate transmission resources based on a resource reservation contained in the received sidelink transmission.
Statement 5. The method of Statement 4, wherein the resource reservation is contained in sidelink control information, SCI, contained in the received sidelink transmission.
Statement 6. The method of Statement 4, wherein determining that the second transmission resource is available for use comprises determining that the second transmission resource has not been reserved by another device based on the updated set of candidate transmission resources.
Statement 7. The method of any previous Statement, wherein determining that the second transmission resource is available for use is based on a reference signal received power, RSRP, measurement of received sidelink transmission in the channel.
Statement 8. The method of Statement 7, wherein determining the set of candidate transmission resources comprises comparing a RSRP measurement of the channel to a first threshold, and updating the set of candidate transmission resources comprises comparing a RSRP measurement of the channel to a second threshold, wherein the first threshold is different from the second threshold.
Statement 9. The method of any previous Statement, further comprising reserving the first transmission resource for transmission of the TB, and reserving a third transmission resource in a third time slot that is later in time than the first time slot for retransmission of the TB.
Statement 10. The method of Statement 9, further comprising:
performing opportunistic retransmission of the TB, wherein performing opportunistic retransmission of the TB comprises:
after the first time slot, performing a second channel access procedure in the channel and a second resource sensing procedure in the channel;
determining, in response to the second channel access procedure and the second resource sensing procedure, that a fourth transmission resource in a fourth time slot of the channel is available for use, wherein the fourth time slot is earlier in time than the third time slot; and
retransmitting the TB using the fourth transmission resource.
Statement 11. The method of Statement 10, wherein opportunistic retransmission is performed only if a time gap between the third time slot and the fourth time slot is greater than a threshold value.
Statement 12. The method of Statement 11, wherein the threshold value is selected to be large enough for the wireless device to receive feedback from the opportunistic transmission before the first time slot.
Statement 13. The method of any previous Statement, wherein the opportunistic transmission is performed only if a time gap between the second time slot and the first time slot is greater than a threshold value.
Statement 14. The method of any previous Statement, further comprising:
determining that a condition has been fulfilled; and
performing the opportunistic transmission in response to fulfillment of the condition.
Statement 15. The method of Statement 14, wherein the condition comprises one or more of:
a congestion level of the channel being above a predetermined threshold level
the congestion level of the channel being below the predetermined threshold level;
a priority level of the TB being above a predetermined threshold level;
a priority level of the TB being below a predetermined threshold level;
an indication from a network node indicating absence of non-sidelink devices using the channel.
Statement 16. The method of any previous Statement, further comprising:
after performing the opportunistic transmission and/or opportunistic retransmission, refraining from performing a subsequent opportunistic transmission for a predetermined time period.
Statement 17. The method of any previous Statement, further comprising:
after performing the opportunistic transmission, refraining from performing a subsequent opportunistic transmission until after the first time slot.
Statement 18. The method of any previous Statement, further comprising:
following the opportunistic transmission using the second transmission resource in the second time slot, refraining from transmitting using the first transmission resource in the first time slot.
Statement 19. The method of any previous Statement, wherein selecting the first transmission resource comprises selecting the first transmission resource at random from the set of candidate transmission resources.
Statement 20. The method of any previous Statement, wherein performing the channel access procedure comprises sensing a subchannel of the channel, the subchannel containing the second transmission resource, within a channel access window prior to the first time slot.
Statement 21. The method any previous Statement, performing resource selection of transmission resources comprises sensing the channel within a sensing window, wherein the set of candidate transmission resources falls within a selection window that is later in time than the sensing window.
Statement 22. The method of any previous Statement, wherein selecting the first transmission resource comprises selecting the first transmission resource to reduce bandwidth fragmentation of the channel.
Statement 23. The method of Statement 22, wherein selecting the first transmission resource comprises selecting the first transmission resource such that a number of time slots within the selection window having a single occupied subchannel following selection of the first transmission resource is minimized.
Statement 24. The method of Statement 22, wherein selecting the first transmission resource comprises selecting the first transmission resource such that a number of time slots within the selection window having all subchannels occupied following selection of the first transmission resource is maximized.
Statement 25. The method of Statement 20 or 22, wherein selecting the first transmission resource to reduce bandwidth fragmentation of the channel comprises selecting a resource in a slot for which a previously received reservation has reserved another resource.
Statement 26. The method of Statement 20 or 22, wherein selecting the first transmission resource to reduce bandwidth fragmentation of the channel comprises assigning a higher probability of selection to resources in a slot for which a previously received reservation has reserved another resource compared to resources in a slot for which for which no previously received reservation has reserved another resource.
Statement 27. The method of Statement 20 or 22, wherein selecting the first transmission resource to reduce bandwidth fragmentation of the channel comprises comparing a lower RSRP threshold to RSRP measurements associated with resources in a slot for which a previously received reservation has reserved another resource compared to resources in a slot for which for which no previously received reservation has reserved another resource.
Statement 28. The method of any previous Statement, further comprising:
after the opportunistic transmission, re-selecting transmission resources to reduce bandwidth fragmentation of the channel.
Statement 29. The method of any previous Statement, wherein the opportunistic transmission comprises sidelink control information, SCI, that reserves an additional transmission resource for retransmission of the TB or transmission of a new TB.
Statement 30. The method of Statement 29, wherein the SCI reserves a plurality of subsequent transmission resources in subsequent time slots for retransmission of the TB, wherein time intervals between successive subsequent time slots for retransmissions are increased compared to previous time intervals between successive subsequent time slots for retransmissions.
Statement 31. The method of Statement 30, wherein time intervals between successive subsequent time slots for retransmissions are doubled compared to previous time intervals between successive subsequent time slots for retransmissions.
Statement 32. The method of Statement 29, wherein the additional transmission resource reserved by the opportunistic transmission is later in time than the first time slot.
Statement 33. The method of Statement 29, wherein the additional transmission resource reserved by the opportunistic transmission includes the first transmission resource.
Statement 34. The method of Statement 29, wherein the additional transmission resource reserved by the opportunistic transmission comprises a newly selected transmission resource.
Statement 35. The method of any of Statements 29 to 34, wherein the additional transmission resource reserved by the opportunistic transmission is selected from the set of candidate transmission resources.
Statement 36. The method of Statement 29, further comprising:
transmitting SCI in the first transmission resource that reserves a third transmission resource for retransmission in a third time slot, wherein the additional transmission resource is in a first subchannel of the third time slot that is contiguous with a second subchannel containing the third transmission resource.
Statement 37. The method of any previous Statement, further comprising:
determining that a plurality of transmission resources are available in the second time slot; and
randomly selecting one of the plurality of transmission resources that are available in the second time slot for transmitting the TB in the second time slot.
Statement 38. The method of any previous Statement, wherein the channel comprises a shared spectrum channel.
Statement 39. The method of any previous Statement, wherein performing the resource selection is triggered by a failed channel access by the wireless device.
Statement 40. A wireless device configured to perform operations according to any of Statements 1 to 39.
Statement 41. A wireless device, comprising:
a processing circuit;
a transceiver circuit coupled to processing circuit; and
a memory coupled to the processing circuit, wherein the memory comprises computer program instructions that, when executed by the processing circuit, cause the wireless device to perform operations according to any of Statements 1 to 39.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-33. (canceled)

34. A method performed by a wireless device, comprising:
determining a set of candidate transmission resources in a channel for transmission of a transport block (TB);
selecting, from the set of candidate transmission resources, a first transmission resource for transmission of the TB in a first time slot of the channel; and
performing opportunistic transmission of the TB, wherein performing opportunistic transmission of the TB comprises:
prior to the first time slot, performing a first channel access procedure in the channel and a first resource sensing procedure in the channel;
determining, in response to the first channel access procedure and the first resource sensing procedure, that a second transmission resource in a second time slot of the channel is available for use, wherein the second time slot is earlier in time than the first time slot; and
transmitting the TB using the second transmission resource.

35. The method of claim 34, wherein determining that the second transmission resource is available comprises determining that the channel is clear based on the first channel access procedure, and determining that the second transmission resource has not been reserved by another device based on the first resource sensing procedure.

36. The method of claim 34, further comprising selecting a resource in the second time slot, wherein the selected resource in the second time slot belongs to the set of candidate resources.

37. The method of claim 35, further comprising:
after performing the resource selection, receiving a sidelink transmission in the channel; and
updating the set of candidate transmission resources based on a resource reservation contained in the received sidelink transmission.

38. The method of claim 37, wherein determining that the second transmission resource is available for use comprises determining that the second transmission resource has not been reserved by another device based on the updated set of candidate transmission resources.

39. The method of claim 34, wherein determining that the second transmission resource is available for use is based on a reference signal received power (RSRP) measurement of received sidelink transmission in the channel.

40. The method of claim 39, wherein determining the set of candidate transmission resources comprises comparing an RSRP measurement of the channel to a first threshold, and updating the set of candidate transmission resources comprises comparing an RSRP measurement of the channel to a second threshold, wherein the first threshold is different from the second threshold.

41. The method of claim 34, further comprising reserving the first transmission resource for transmission of the TB, and reserving a third transmission resource in a third time slot that is later in time than the first time slot for retransmission of the TB.

42. The method of claim 41, further comprising:
performing opportunistic retransmission of the TB, wherein performing opportunistic retransmission of the TB comprises:
after the first time slot, performing a second channel access procedure in the channel and a second resource sensing procedure in the channel;
determining, in response to the second channel access procedure and the second resource sensing procedure, that a fourth transmission resource in a fourth time slot of the channel is available for use, wherein the fourth time slot is earlier in time than the third time slot; and
retransmitting the TB using the fourth transmission resource.

43. The method of claim 42, wherein opportunistic retransmission is performed in response to a time gap between the third time slot and the fourth time slot being greater than a third threshold.

44. The method of claim 34, wherein the opportunistic transmission is performed in response to a time gap between the second time slot and the first time slot being greater than a fourth threshold.

45. The method of claim 34, further comprising:
determining that a condition has been fulfilled; and
performing the opportunistic transmission in response to fulfillment of the condition, wherein the condition comprises one or more of:
a congestion level of the channel being above a predetermined threshold level;
the congestion level of the channel being below the predetermined threshold level;
a priority level of the TB being above a predetermined threshold level;
a priority level of the TB being below a predetermined threshold level; and
an indication from a network node indicating absence of non-sidelink devices using the channel.

46. The method of claim 34, further comprising:
after performing the opportunistic transmission, refraining from performing a subsequent opportunistic transmission for a predetermined time period;
after performing the opportunistic transmission, refraining from performing a subsequent opportunistic transmission until after the first time slot; and/or
following the opportunistic transmission, using the second transmission resource in the second time slot, refraining from transmitting using the first transmission resource in the first time slot.

47. The method of claim 34, wherein:
selecting the first transmission resource comprises selecting the first transmission resource at random from the set of candidate transmission resources; and/or
performing the channel access procedure comprises sensing a subchannel of the channel, the subchannel containing the second transmission resource, within a channel access window prior to the first time slot.

48. The method of claim 34, wherein performing resource selection of transmission resources comprises sensing the channel within a sensing window, wherein the set of candidate transmission resources falls within a selection window that is later in time than the sensing window.

49. The method of claim 34, wherein selecting the first transmission resource comprises selecting the first transmission resource to reduce bandwidth fragmentation of the channel.

50. The method of claim 49, wherein selecting the first transmission resource comprises:
selecting the first transmission resource such that a number of time slots within the selection window having a single occupied subchannel following selection of the first transmission resource is minimized; or
selecting the first transmission resource such that a number of time slots within the selection window having all subchannels occupied following selection of the first transmission resource is maximized.

51. The method of claim 49, wherein selecting the first transmission resource to reduce bandwidth fragmentation of the channel comprises:
selecting a resource in a slot for which a previously received reservation has reserved another resource;
assigning a higher probability of selection to resources in a slot for which a previously received reservation has reserved another resource compared to resources in a slot for which no previously received reservation has reserved another resource; or
comparing a lower reference signal received power (RSRP) threshold to RSRP measurements associated with resources in a slot for which a previously received reservation has reserved another resource compared to resources in a slot for which no previously received reservation has reserved another resource.

52. The method of claim 34, further comprising:
after the opportunistic transmission, re-selecting transmission resources to reduce bandwidth fragmentation of the channel.

53. The method of claim 34, wherein the opportunistic transmission comprises sidelink control information (SCI) that reserves an additional transmission resource for retransmission of the TB or transmission of a new TB.

54. The method of 53, wherein the SCI reserves a plurality of subsequent transmission resources in subsequent time slots for retransmission of the TB, wherein time intervals between successive subsequent time slots for retransmissions are increased compared to previous time intervals between successive subsequent time slots for retransmissions.

55. The method of claim 53, further comprising:
transmitting SCI in the first transmission resource that reserves a third transmission resource for retransmission in a third time slot, wherein the additional transmission resource is in a first subchannel of the third time slot that is contiguous with a second subchannel containing the third transmission resource.

56. The method of claim 34, further comprising:
determining that a plurality of transmission resources are available in the second time slot; and
randomly selecting one of the plurality of transmission resources that are available in the second time slot for transmitting the TB in the second time slot.

57. The method of claim 34, wherein the channel comprises a shared spectrum channel.

58. The method of claim 34, wherein performing the resource selection is triggered by a failed channel access by the wireless device.

59. A wireless device comprising communication interface circuitry configured to communicate with a wireless network and further comprising processing circuitry operatively coupled to the communication interface circuitry and configured to control the wireless device to:
determine a set of candidate transmission resources in a channel for transmission of a transport block (TB);
select, from the set of candidate transmission resources, a first transmission resource for transmission of the TB in a first time slot of the channel; and
perform opportunistic transmission of the TB, wherein performing opportunistic transmission of the TB comprises:
prior to the first time slot, performing a first channel access procedure in the channel and a first resource sensing procedure in the channel;
determining, in response to the first channel access procedure and the first resource sensing procedure, that a second transmission resource in a second time slot of the channel is available for use, wherein the second time slot is earlier in time than the first time slot; and
transmitting the TB using the second transmission resource.
